(19) United States
(12) Patent Application Publication
(10) Pub. No.: US 2026/0104586 A1
(43) Pub. Date: Apr. 16, 2026

(54) HEAD-UP DISPLAY APPARATUS

(71) Applicant: Nippon Seiki Co., Ltd., Niigata (JP)

(72) Inventors: Tomohiro Haryu, Niigata (JP); Norio Suzuki, Niigata (JP)

(21) Appl. No.: 19/342,781

(22) Filed: Sep. 29, 2025

(30) Foreign Application Priority Data
Oct. 11, 2024 (JP) 2024-179284

(51) Int. Cl. G02B 27/01; B60K 35/23

(52) U.S. Cl. CPC G02B 27/0101; B60K 35/23; G02B 27/0149; G02B 2027/0154

(57) ABSTRACT

A head-up display apparatus includes a movable correction mirror located on an optical path of display light L1 representing a virtual image, and configured to be pivotable between a reflection position at which display light L2 representing a real image is reflected toward a windshield and a retraction position at which the movable correction mirror is retracted from the optical path of the display light L1, and a driving mechanism that drives the movable correction mirror to be pivoted. A liquid crystal display panel is placed on the opposite side to a reflective surface of the movable correction mirror, in a state where the movable correction mirror is pivoted to the reflection position, the display light L2 is output toward the windshield, and in a state where the movable correction mirror is pivoted to the retraction position, the display light L1 is output toward the windshield.

### TECHNICAL FIELD

The present invention relates to a head-up display apparatus for providing a desired display to a viewer.

### BACKGROUND ART

In the related art, a head-up display apparatus as described in, for example, JP 4941070 B1 is known. Such a head-up display apparatus includes two displays, in which display light of one of the two displays is transmitted through a half mirror and display light of the other of the two displays is reflected by a half mirror so that optical path lengths of the two display light beams to a windshield are made different to allow a driver to view the presence of two virtual images corresponding to the two display light beams.

### PRIOR ART DOCUMENT

### Patent Document

Patent Document 1: JP 4941070 B1

### SUMMARY OF INVENTION

### Technical Problem

However, in the above-mentioned head-up display apparatus in the related art, the display light from a light source of the one display is reflected only by the reflectance of the half mirror, and thus, a sufficient amount of light cannot be output. The display light from a light source of the other display is transmitted only by the transmittance of the half mirror, and thus, a sufficient amount of light cannot be output. As a result, there is a problem that the luminance efficiency of each display light beam is deteriorated.

Therefore, the present invention has been made in consideration of the above problems, and an object thereof is to provide a head-up display apparatus capable of providing a high luminance efficiency for both light beams from two light sources.

### Solution to Problem

The present invention provides a head-up display apparatus 100 including an emission port 17, the head-up display apparatus 100 for emitting display light M1, L1/M2, L2 from the emission port 17 toward a light transmitting member 30 to allow a driver 40 of a vehicle to view display images IMG2, IMG1 represented by the display light M1, L1/M2, L2. The head-up display apparatus 100 includes a first display unit 121 that includes a first display element, transmits light output by a first light source 125, and displays a first display image IMG2, a second display unit 111 that includes a second display element, transmits light output by a second light source 115, and displays a second display image IMG1, a first mirror 130 being located on an optical path of the second light beams M1, L1 representing the second display image IMG1 displayed on the second display unit 111 and being pivotable between a reflection position reflecting the first light beams M2, L2 representing the first display image IMG2 displayed on the first display unit 121 toward the light-transmitting member 30 and a retraction position where the first mirror 130 is retracted from the optical path of the second light beams M1, L1, and a drive unit 133 that drives the first mirror 130 to pivot between the reflection position and the retraction position, in which the second display unit 111 is placed opposite to a reflection surface of the first mirror 130 at the reflection position, in a state where the first mirror 130 is pivoted to the reflection position, the first display image IMG2 is viewed by the driver 40 by outputting the first light beams M2, L2 to the light-transmitting member 30, and in a state where the first mirror 130 is pivoted to the retraction position, the second display image IMG1 is viewed by the driver 40 by outputting the second light beams M1, L1 to the light-transmitting member 30.

### Advantageous Effects of Invention

According to the present invention, it is possible to provide a head-up display apparatus capable of providing a high luminance efficiency for both light beams from two light sources.

### BRIEF DESCRIPTION OF DRAWINGS

FIG. 1 is a conceptual diagram illustrating a placement position of a head-up display apparatus according to one embodiment of the present invention in a vehicle.

FIG. 2 is a schematic cross-sectional view illustrating an overall configuration of the head-up display apparatus.

FIG. 3 is a schematic cross-sectional view illustrating a display state of a virtual image in the head-up display apparatus.

FIG. 4 is a schematic cross-sectional view illustrating a display state of a real image in the head-up display apparatus.

### DESCRIPTION OF EMBODIMENTS

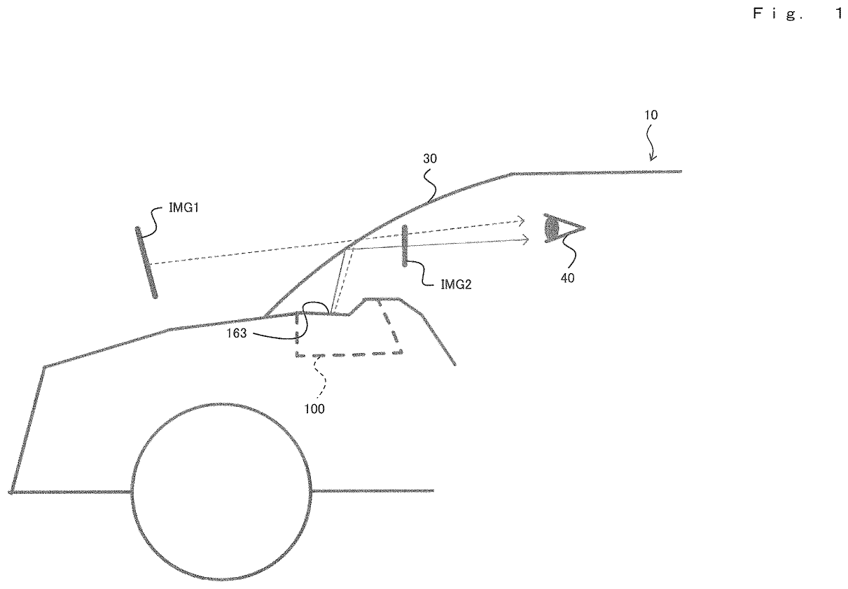

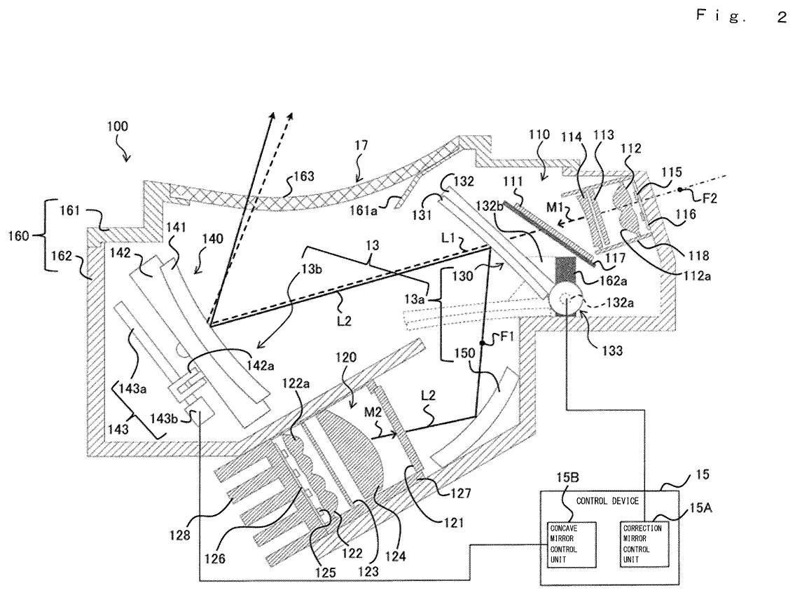

Hereinafter, a head-up display apparatus according to one embodiment of the present invention will be described with reference to FIG. 2 or FIG. 1. As illustrated in FIG. 1, a head-up display apparatus 100 according to the present embodiment is placed below a windshield 30 of a vehicle 10 (for example, inside an instrument panel) and allows a driver 40 to view a real image IMG2 inside the vehicle (light-transmitting member), and a virtual image IMG1 outside the vehicle at the same time across the windshield 30.

### Outline of Head-Up Display Apparatus

FIG. 2 is a diagram illustrating an overall configuration of the head-up display apparatus 100 according to the present embodiment. In FIG. 2, the head-up display apparatus 100 includes a first display 120, a second display 110, a reflection portion 13, and a control device 15, which are housed in a housing 160.

### Housing

The housing 160 includes an upper case 161 and a lower case 162.

The upper case 161 includes an opening 17 (emission port) through which display light L1, L2 described below are output, and the opening 17 includes a window portion 163 for protecting the inside. The window portion 163 is formed of a light-transmitting resin (for example, acrylic), and has a curved shape in this example.

A light-shielding wall 161a is provided in the upper case 161 to prevent external light other than sunlight from entering the first display 120 and the second display 110 to make the virtual image IMG1 and the real image IMG2 difficult to see (washout). The light-shielding wall 161a has a flat plate shape and is formed to hang down obliquely from the top of the upper case 161.

### First Display

The first display 120 includes a light-emitting diode 125 (first light source), a liquid crystal display panel 121 (first display unit) provided on the opening 17 side along an optical path from the light-emitting diode 125, lens members 122, 123, and 124, a rigid wiring board 126, a case body 127, and a heat sink 128.

The light-emitting diode 125 emits light in a visible wavelength range, for example, white light. A plurality of the light-emitting diodes 125 are arranged adjacent to one another and mounted on the rigid wiring board 126.

The lens member 122 includes a plurality of convex lens portions 122a. Each convex lens portion 122a is provided at a position corresponding to the light emitting diode 125, and collects light emitted by the light-emitting diode 125.

The liquid crystal display panel 121 includes a thin film transistor (TFT) typed first display element (not illustrated), and generates the display light L2 by transmitting light M2 emitted from the light-emitting diode 125 and transmitted through the lens members 122, 123, and 124, and also displays the above-mentioned real image (first display image) IMG2, which is a display image formed in front of the driver 40. The first display element can generate display light representing any image in accordance with a control signal sent from the control device 15.

The case body 127 is formed of resin, and the liquid crystal display panel 121 is provided at an open end of the case body 127.

The heat sink 128 is placed on a rear surface of the rigid wiring board 126. The heat sink 128 dissipates heat generated by the light-emitting diode 125.

### Second Display

The second display 110 includes a light-emitting diode 115 (second light source), a liquid crystal display panel 111 (second display unit) provided on the opening 17 side along an optical path from the light-emitting diode 115, lens members 112, 113, and 114, a rigid wiring board 116, a display holder 117, and a case body 118.

The light-emitting diode 115 emits light in the visible wavelength range, for example, white light. A plurality of the light-emitting diodes 115 are arranged adjacent to one another and mounted on the rigid wiring board 116.

The lens members 112, 113, and 114 are formed of a light-transmitting resin such as polycarbonate, and are placed between the liquid crystal display panel 111 and the light-emitting diode 115. The lens member 112 includes a plurality of convex lens portions 112a. Each convex lens portion 112a is provided at a position corresponding to the light-emitting diode 115, and collects light emitted by the light-emitting diode 115.

The liquid crystal display panel 111 includes a TFT-typed second display element (not illustrated) and generates the display light L1 by transmitting light M1 emitted from the light-emitting diode 115 and transmitted through the lens members 112, 113, and 114, and also displays the virtual image (second display image) IMG1, which is a display image formed in front of the driver 40. The second display element is capable of generating display light representing any image according to a control signal sent from the control device 15. The liquid crystal display panel 111 is held and placed in front of the opening of the case body 118 by the display holder 117.

The case body 118 is formed of black resin and has a generally rectangular cylindrical shape.

It is noted that the liquid crystal display panel 111 of the second display 110 is arranged along the optical path of the display light L1 (in the order of the optical path) on the opening 17 side relative to the position of a second optical focal point F2 of the imaging optical system including the windshield 30 and a reflector 140 described below.

In FIG. 2, in reality, countless light beams (display light) are output from the liquid crystal display panel 121 and the liquid crystal display panel 111, however, the strongest light beam that is emitted from the center of the liquid crystal display panel 121 and passes through the center of the eye box is illustrated as a representative light beam by the display light L2, and the strongest light beam that is emitted from the center of the liquid crystal display panel 111 and passes through the center of the eye box is illustrated as a representative light beam by the display light L1. In FIG. 2, for convenience, the display light L2 is indicated by a solid line, and the display light L1 is indicated by a dashed line.

In the first display 120 and the second display 110, in addition to the above components, optical components such as a condenser lens, a lenticular lens, a diffuser, and a polarizer may be arranged at any position downstream of each of the light-emitting diodes 125 and 115.

### Reflection Portion

The reflection portion 13 reflects, toward the windshield 30, the display light L2 representing the display image displayed on the liquid crystal display panel 121 and the display light L1 representing the display image displayed on the liquid crystal display panel 111.

The reflection portion 13 includes a first mirror portion 13a and a second mirror portion 13b.

### First Mirror Portion

The first mirror portion 13a includes a reflector 150 that reflects the display light L2 output from the liquid crystal display panel 121 toward the movable correction mirror 130, and the movable correction mirror 130 (first mirror) that reflects the display light L2 output from the reflector 150 toward the second mirror portion 13b. It is noted that the reflector 150 and the movable correction mirror 130 have mirror surfaces and are formed into a complex free-form surface to correct distortion of the display light L2 so that distortion of the image viewed by the driver 40 is corrected.

### Reflector

The reflector 150 is placed closer to the opening 17 than the first display 120 along the optical path of the display light L2 (in the order of the optical path), and includes a concave mirror (not illustrated) and a mirror holder (not illustrated), with the concave mirror being held by the mirror holder. As illustrated in FIG. 2, the reflector 150 is placed on the first display 120 side from a first optical focal point F1 of the imaging optical system including the windshield 30, the movable correction mirror 130, and the reflector 140. The reflector 150 reflects the display light L2, which is output from the liquid crystal display panel 121 and reflected by the movable correction mirror 130 at the above-mentioned reflection position, toward the movable correction mirror 130 placed above the reflector 150.

### Movable Correction Mirror

The movable correction mirror 130 includes a concave mirror 131 (mirror body) and a mirror holder 132 (holder) that houses and holds the concave mirror 131.

The concave mirror 131 is formed of a highly reflective mirror having a coating formed by, for example, sputtering, and reflecting approximately 97% of incident light. It is noted that the concave mirror 131 may be formed of a clear mirror that reflects approximately 90% of the incident light.

The mirror holder 132 is configured to be pivotable about a substantially horizontal axis of a driving mechanism 133 (drive unit) by the driving mechanism 133 between a reflection position indicated by a solid line and a retraction position indicated by a dashed line in FIG. 2. The reflection position is a position where the movable correction mirror 130 is located on the optical path of the display light L1 to strike the rear surface of the mirror holder 132 with the display light L1 and to reflect the display light L2 toward the reflector 140. The retraction position is a position where the movable correction mirror 130 is out of the optical path of the display light L1 and allows the display light L1 to pass therethrough while reflecting the display light L2 toward the reflector 150. The mirror holder 132 includes a contacted portion 132b, which, in pivoted by the driving mechanism 133, contacts a stopper portion 162a formed of a casing abutment surface to position the movable correction mirror 130 (see FIG. 2), and such a contact state is the above-mentioned reflection position.

The driving mechanism 133 includes, for example, a gear box (not illustrated) and a motor (not illustrated), and is connected to a shaft 132a of the mirror holder 132 via an appropriate coupling or the like.

It is noted that in this example, the shaft 132a is arranged at the lower end of the mirror holder 132, so that the entire concave mirror 131 can be located on the optical path of the display light L1 (second light beam) or completely retracted from the optical path by rotation. That is, if the shaft 132a is placed at the center of the mirror holder 132, the entire concave mirror 131 cannot be completely retracted from the optical path of the display light L1, and thus, such a situation is avoided.

When the movable correction mirror 130 is at the above-mentioned reflection position, the movable correction mirror 130 reflects and folds back the display light L2 (first light beam) from the substantially vertical direction reflected by the reflector 150 toward the reflector 140. It is noted that when the movable correction mirror 130 is at the above mentioned reflection position, the second display 110 including the liquid crystal display panel 111 is located on the opposite side of the movable correction mirror 130 to the reflecting surface of the concave mirror 131. When the movable correction mirror 130 is at the above-mentioned retraction position, the first display 120 basically displays nothing, but even if the first display 120 displays something, the display light L1 representing the virtual image IMG1 displayed on the liquid crystal display panel 111 does not pass through the movable correction mirror 130.

### Second Mirror Portion

The second mirror portion 13b includes the reflector 140 whose surface includes a mirror surface.

### Reflector

The reflector 140 is configured to be pivotable, and includes a concave mirror 141 that reflects the display light L1, L2 to be projected onto the windshield of the vehicle, a mirror holder 142 that holds the concave mirror 141, and a driving mechanism 143.

The concave mirror 141 has a free-form surface, and is formed by depositing aluminum (Al) onto a resin such as polycarbonate (PC) to form a reflective film. The mirror holder 12 is formed of a resin such as PBT. It is noted that the concave mirror 141 and the mirror holder 142 may be formed of a metal such as aluminum.

The driving mechanism 143 includes a linear guide 143a and a motor 143b. A fitting portion 142a provided on the mirror holder 142 is fastened to the linear guide 143a, and when the motor 143b is driven, the positioning angle of the concave mirror 141 held by the mirror holder 142 is adjusted, and the projection direction of the display light L1, L2 is adjusted.

The reflector 140 reflects, toward the upper opening 17, the display light L2 reflected and folded back by the movable correction mirror 130 in the above-mentioned reflection position, or the display light L1 incident from the liquid crystal display panel 111 without passing through the movable correction mirror 130. Then, the display light L2 or the display light L1 reflected by the reflector 140 is output to the windshield 30 through the window portion 163, and the driver 40 views the display image represented by the display light L2 as the real image IMG2, or the display image represented by the display light L1 as the virtual image IMG1.

In particular, at that time, the reflector 140 is pivoted by the driving mechanism 143 in accordance with the eye position of the driver 40, and the directions where the display light L2 and the display light L1 are output are freely changed to adjust the position of the image. For example, it may be desirable to make the angle of the display surface different between a case where the display light L2 displays the real image IMG2 and a case where the display light L1 displays the virtual image IMG1. An example includes such a case where it is desirable that the virtual image IMG1 is displayed as if the virtual image IMG1 is inclined with respect to the road surface, and the real image IMG2 is displayed as if the real image IMG2 is standing perpendicular to the road surface. In response thereto, if the above adjustment is provided through the rotational drive of the driving mechanism 143, it is possible to display the display images at angles suitable for the real image IMG2 and the virtual image IMG1, respectively.

### Control Device

The control device 15 functionally includes a correction mirror control unit 15A and a concave mirror control unit 15B.

The correction mirror control unit 15A can finely adjust the angle of the concave mirror 131 via the driving mechanism 133 to finely adjust the uniformity and position of the image of the real image IMG2.

The concave mirror control unit 15B can adjust the projection direction of the display light L1, L2 by adjusting the arrangement angle of the concave mirror 141 via the driving mechanism 143 as described above.

It is noted that in addition to the above, the control device 15 also has a function of controlling display content and display switching of the liquid crystal display panel 121 and the liquid crystal display panel 111 (detailed description is omitted). That is, although a detailed explanation is omitted, for example, the control device 15 controls the first display 120 and the second display 110 in coordination with each other, turns on/off the light-emitting diode 125, turns on/off the light-emitting diode 115, controls the display content of the liquid crystal display panel 121, and controls the display content of the liquid crystal display panel 111 to generate the display light L2 output from the first display 120 and the display light L1 output from the second display 110.

### Display of Real Image and Virtual Image

With the head-up display apparatus having the above configuration, the driver 40 of the vehicle 10 can view the display light L2 reflected on the windshield 30, and can see the real image IMG2 inside the vehicle relative to the windshield 30, i.e., in front of the windshield 30 as seen by the driver 40. Upon viewing the display light L1 reflected on the windshield 30, the driver 40 can view the virtual image IMG1 outside the vehicle relative to the windshield 30, i.e., on the far side of the windshield 30 as viewed from the driver 40.

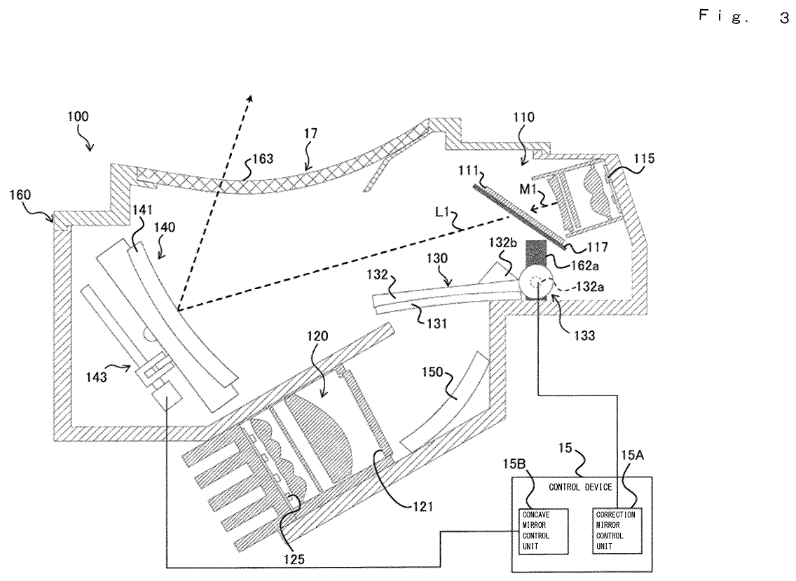

FIG. 3 is a diagram illustrating a state in which the virtual image IMG1 is displayed by the second display 110 in the head-up display apparatus 100. As described above, in such a case, the correction mirror control unit 15A of the control device 15 controls the driving mechanism 133, as a result, the movable correction mirror 130 rotates in the counterclockwise direction as illustrated in the figure, with the center of the shaft 132a as the axis, until the movable correction mirror 130 is just about to abut against the lower case 162, and then retreats from the optical path of the display light L1 to a retraction position. It is noted that the mirror holder 132 may include a stopper portion (not illustrated) protruding toward the concave mirror 131 and abutting against the lower case 162.

As a result, as described above, the display light L1 representing the virtual image IMG1 displayed on the liquid crystal display panel 111 does not pass through the movable correction mirror 130. The display light L1 incident on the reflector 140 from the liquid crystal display panel 111 without passing through the movable correction mirror 130 is reflected toward the opening 17 and output to the windshield 30, and the driver 40 can view the display image represented by the display light L1 as the virtual image IMG1.

It is noted that the virtual image IMG1 displays information that is highly likely to need to draw the attention of the driver 40, such as vehicle information including the speed of the vehicle 10 and the engine RPM, a route guidance display including turn-by-turn and a map, a blind spot indicator, and a warning display including a speed limit exceeding warning. Such displays provide a driving environment with reduced need for a viewpoint movement and an eye focal length adjustment.

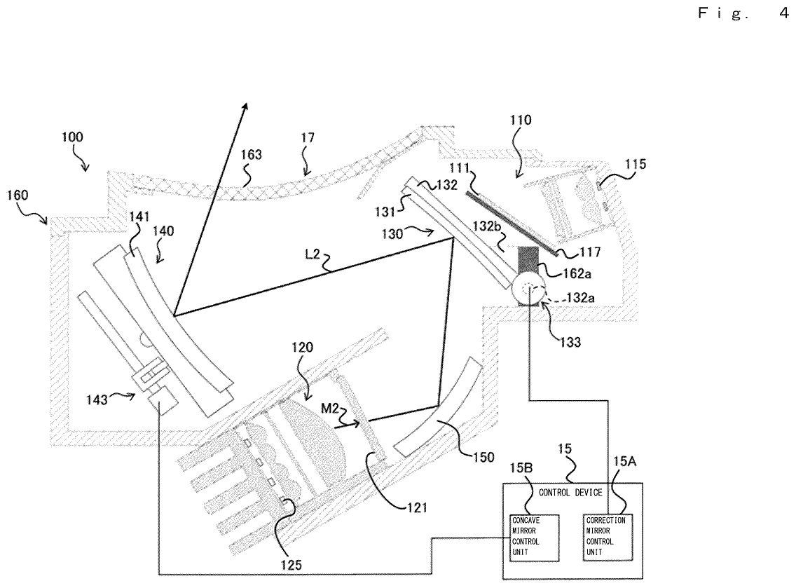

FIG. 4 is a diagram illustrating a state in which the real image IMG2 is displayed by the first display 120 in the head-up display apparatus 100. As described above, in such a case, the correction mirror control unit 15A of the control device 15 controls the driving mechanism 133, so that the movable correction mirror 130 rotates in the clockwise direction as illustrated (until the contacted portion 132b of the mirror holder 132 abuts against the stopper portion 162a) with the center of the shaft 132a as the axis, and is positioned with high precision to the reflection position on the optical path of the display light L1.

As a result, as described above, the display light L2 representing the real image IMG2 displayed on the liquid crystal display panel 121 is reflected and folded back by the movable correction mirror 130 at the reflection position, and is further reflected by the reflector 140 toward the upper opening 17. The display light L2 reflected by the reflector 140 is output to the windshield 30 through the window portion 163, and the driver 40 can view the display image represented by the display light L2 as the real image IMG2.

It is noted that examples of the real image IMG2 may include entertainment content, an assistant or agent supporting the driver 40, or a character representing such an assistant or agent, and are displayed in front of the windshield 30 as seen by the driver 40.

It is noted that the real image IMG2 and the virtual image IMG1 include background portions in addition to characters and icons indicating the above information, and as viewed from the driver 40 in a plan view, the real image IMG2 and the virtual image IMG1 have, for example, a substantially rectangular shape.

### Effects of Embodiment

As described above, in the present embodiment, the movable correction mirror 130 is configured to be driven by the driving mechanism 133 to pivot between the reflection position and the retraction position. When the real image IMG2 is to be viewed by the driver 40, the movable correction mirror 130 can be pivoted to the reflection position to be positioned on the optical path of the display light L1 from the second display 110, and the display light L2 from the first display 120 can be reflected and output to the windshield 30. As a result, a sufficient amount of light can be output compared to a case where a half mirror is used as the movable correction mirror 130 to reflect the display light L2 from the first display 120 by a predetermined reflectance.

On the other hand, when the virtual image IMG1 is to be viewed by the driver 40, the movable correction mirror 130 can be pivoted to the retraction position to deviate from the optical path of the display light L1, and the display light L1 from the second display 110 can be output to the windshield 30. As a result, a sufficient amount of light can be output compared to a case where a half mirror is employed for the movable correction mirror 130 to transmit the display light L1 from the second display 110 by the transmittance. As a result, according to the present embodiment, a high luminance efficiency can be obtained for both the display light L2 from the first display 120 and the display light L1 from the second display 110. This also makes it possible to reduce power consumption, and thus, it is possible to reduce the size of the head-up display apparatus 100 by saving power and reducing the size of the light source that emits the display light.

In particular in the present embodiment, when the real image IMG2 is viewed, the display light can be emitted onto the windshield 30 via the route of the first display 120 to the reflector 150 to the movable correction mirror 130 at the reflection position to the reflector 140 to the opening 17, and when the virtual image IMG1 is to be viewed, the display light can be emitted onto the windshield 30 via the route of the second display 110 to (without passing through the movable correction mirror 130 in the retraction position) to the reflector 140 to the opening 17.

In particular, in the present embodiment, when the movable correction mirror 130 is pivoted from the retraction position to the reflection position, the movable correction mirror 130 can be positioned by the stopper portion 162a, so that a low-precious and inexpensive motor can be used in the driving mechanism 133.

In particular, in the present embodiment, the mirror holder 132 housing the concave mirror 131 is driven by the driving mechanism 133, so that the movable correction mirror 130 can be pivoted between the reflection position and the retraction position.

In particular, in the present embodiment, the movable correction mirror 130 has a function of correcting distortion of the display light L1, and the concave mirror 141 of the reflector 140 includes a free-form surface to improve the image quality of the real image IMG2 and the virtual image IMG1.

It is noted that the present invention is not limited to the above-described embodiment, and various modifications are possible without departing from the spirit and technical concept of the present invention.

### (1) Case Where Reflector 140 is Omitted

In the above embodiment, a configuration is employed in which the reflector 140 is provided between the movable correction mirror 130 and the opening 170 along the optical path of the display light L2, L1, and the display light L2, L1 from the movable correction mirror 130 is reflected toward the opening 17, but the present invention is not limited thereto. That is, the present invention is applicable to a configuration without the reflector 140 as described in, for example, JP 63-164038 Y, and can provide the effects similar to those of the above embodiment.

That is, in such a case, when a virtual image is displayed, as described above, the movable correction mirror 130 retracts to the retraction position under the control of the correction mirror control unit 15A of the control device 15, and the display light L1 representing the virtual image IMG1 displayed on the liquid crystal display panel 111 is output to the windshield 30 through the opening 17 without passing through the movable correction mirror 130, and the driver 40 can view the display image represented by the display light L1 as the virtual image IMG1.

When a real image is displayed, the movable correction mirror 130 is set to the reflection position under the control of the correction mirror control unit 15A of the control device 15, and the display light L2 representing the real image IMG2 displayed on the liquid crystal display panel 121 is reflected by the movable correction mirror 130. The display light L2 reflected and folded back by the movable correction mirror 130 at the reflection position is output to the windshield 30 through the opening 17, and the driver 40 can view the display image represented by the display light L2 as the real image IMG2.

### (2) Other

It is noted that the horizontal direction and the vertical direction described above are illustrated based on the horizontal direction and the vertical direction of the vehicle 10, but the reference for each direction is not limited thereto, and the present disclosure also includes cases in which the entire device is tilted at a predetermined angle while the overall arrangement of each optical component maintains its relative positional relationship depending on the internal shape of the instrument panel and the external shape of the housing 160.

In addition to the above, the methods according to the above embodiments and modifications thereof may be used in appropriate combination.

Although not specifically illustrated, the present invention can be implemented with various modifications without departing from the spirit of the present invention.

### REFERENCE SIGNS LIST

10 . . . Vehicle
13 . . . Reflection portion
13a . . . First mirror portion
13b . . . Second mirror portion
15 . . . Control device
15A . . . Correction mirror control unit
15B . . . Concave mirror control unit
17 . . . Opening (emission port)
30 . . . Windshield (light-transmitting member)
40 . . . Driver
100 . . . Head-up display device
110 . . . Second display
111 . . . Liquid crystal display panel (second display unit)
112 . . . Lens member
112a . . . Convex lens portion
113 . . . Lens member
114 . . . Lens member
115 . . . Light-emitting diode (second light source)
116 . . . Rigid wiring board
117 . . . Display holder
118 . . . Case body
120 . . . First display
121 . . . Liquid crystal display panel (first display unit)
122 . . . Lens member
122a . . . Convex lens portion
123 . . . Lens member
124 . . . Lens member
125 . . . Light-emitting diode (first light source)
126 . . . Rigid wiring board
127 . . . Case body
128 . . . Heat sink
130 . . . Movable correction mirror (first mirror)
131 . . . Concave mirror (mirror body)
132 . . . Mirror holder (holder)
132a . . . Shaft
132b . . . Contacted portion
133 . . . Driving mechanism (drive unit)
140 . . . Reflector
141 . . . Concave mirror
142 . . . Mirror holder
142a . . . Fitting portion
143 . . . Driving mechanism
143a Linear guide
143b . . . Motor
150 . . . Reflector
160 . . . Housing
161 . . . Upper case
161 a . . . Light-shielding wall
162 . . . Lower case
162a Stopper portion
163 . . . Window portion
170 . . . Opening
F1 . . . First optical focal point
F2 . . . Second optical focal point
IMG1 . . . Virtual image (second display image)
IMG2 . . . Real image (first display image)
L1 . . . Display light (second light beam)
L2 . . . Display light (first light beam)
M1 . . . Display light (second light beam)
M2 . . . Display light (first light beam)

1. A head-up display apparatus including an emission port, the head-up display apparatus emitting display light from the emission port toward a light-transmitting member to allow a driver of a vehicle to view a display image represented by the display light, the head-up display apparatus comprising:
a first display unit including a first display element, the first display unit transmitting light output from a first light source and displaying a first display image;
a second display unit including a second display element, the second display unit transmitting light output from a second light source and displaying a second display image;
a first mirror being located on an optical path of a second light beam representing the second display image displayed on the second display unit, and being pivotable between a reflection position at which a first light beam representing the first display image displayed on the first display unit is reflected toward the light-transmitting member and a retraction position at which the first mirror is retracted from the optical path of the second light beam; and
a drive unit that drives the first mirror to pivot between the reflection position and the retraction position, wherein
the second display unit is placed on an opposite side to a reflection surface of the first mirror at the reflection position,
in a state where the first mirror is pivoted to the reflection position, the first light beam is output to the light-transmitting member to allow the driver to view the first display image, and
in a state where the first mirror is pivoted to the retraction position, the second light beam is output to the light-transmitting member to allow the driver to view the second display image.

2. The head-up display apparatus according to claim 1, further comprising: a second mirror that reflects the first light beam reflected by the first mirror toward the emission port when the first mirror is pivoted to the reflection position by the drive unit, and reflects the second light beam from the second display unit toward the emission port when the first mirror is pivoted to the retraction position by the drive unit, wherein
in a state where the first mirror is pivoted to the reflection position, the second mirror reflects the first light beam output from the first display unit and reflected by the first mirror toward the light transmitting member to allow the driver to view the first display image, and
in a state where the first mirror is pivoted to the retraction position, the second mirror reflects the second light beam from the second display unit toward the light-transmitting member to allow the driver to view the second display image.

3. The head-up display apparatus according to claim 2, further comprising: a stopper portion that abuts against the first mirror to position the first mirror at the retraction position when the first mirror is driven by the drive unit from the reflection position toward the retraction position.

4. The head-up display apparatus according to claim 1, wherein the first mirror includes:
a mirror body; and
a holder that houses and holds the mirror body, the holder being pivotable around a substantially horizontal axis, and
the drive unit includes
a motor that pivots the holder.

5. The head-up display apparatus according to claim 2, wherein the first mirror includes a correction mirror that corrects distortion of the display light, and
the second mirror includes a concave mirror having a free-form surface.

6. The head-up display apparatus according to claim 1, wherein the first display image is a real image, and the second display image is a virtual image.
